(19) United States
(12) Patent Application Publication
(10) Pub. No.: US 2007/0181545 A1
(43) Pub. Date: Aug. 9, 2007

(54) Method and apparatus for controlling sample position during material removal or addition

(76) Inventors: James E. Boyette, Lakeworth, FL (US); Jeffrey E. LeClaire, Boca Raton, FL (US); Roy White, Wellington, FL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/347,575

(22) Filed: Feb. 6, 2006

(51) Int. Cl. B23K 26/08

(52) U.S. Cl. 219/121.82; 219/121.68; 219/121.83

(57) ABSTRACT

A method and system includes the accurate positioning of a sample in a multi-axis range of motion. In a preferred embodiment, the present invention enables this movement by combining coarse and fine motion stages. By using a combination of stages and precise measuring means, normal and typical errors are significantly reduced.

### FIELD OF THE INVENTION

The present invention relates generally to a system and method for adjusting or moving a sample upon whose surface a material is to be deposited or removed. More particularly, the present invention relates to a system and method for using a system that removes or ablates material or adds material from a sample surface by use of a lasing device wherein the sample is positioned in multiple dimensions with a high degree of accuracy.

### BACKGROUND OF THE INVENTION

The prior art details the use of translation stages for moving samples in and around a laser beam or other radiated beam such that the beam is used for the removal or addition of material from or to a sample. Such systems may use the beam to remove material from the sample or to modify the surface of the sample. These stages typically use lead screws or linear motors to move a carriage on which the sample is mounted.

The sample is placed onto a mounting surface that is attached to a bearing mounted on rails. Some of these systems may use combinations of stages that move the sample itself and separate stages that are used to modify the direction of the laser beam. This is accomplished by moving various components in the beam delivery path to steer the beam to different locations on the sample surface. Such systems as described in U.S. Pat. No. 6,605,799 to Brandinger et al. use an X, Y stage to position the sample and additional motion control devices to move components in the optical column.

One inherent and serious problem with the prior art involves the well know positional inaccuracies due to Abbe errors when moving in the sample and stages linear directions. Stages are known to have small non-orthogonalities in X, Y and Z that create location errors if moving in any one of these linear axis. When attempting to produce laser induced surface changes in the nanometer range, the resulting Abbe offsets can produce significant errors in position even when the stage makes small changes in X, Y and Z. The offsets can result in significant errors in the location of material removed or surface modifications made on the sample surface. The prior art has no adequate solution for correcting these errors.

In addition, the prior art systems suffer from a second problem in the form of parasitic errors. These errors are a result of undesirable cross coupling of motion from one axis to another. If motion is commanded to the stage in the X direction, for example, in addition to a resulting motion in X, an undesirable motion in translational Y, Z or in the rotational roll, pitch, or yaw axis may occur. This results in a positional error. This cross-coupled or parasitic motion may occur in any of the other degrees of freedom either in one or more of the translational or rotational axis. In all, the present invention may include correction in each of the three translational axes and the three rotational axes for correction in all six degrees of motion.

U.S. Pat. No. 6,656,539 and U.S. Pat. No. 6,333,485 to Haight et al. describes a piezo electric stage for moving the sample that moves approximately orthogonal to an optical axis in two directions. The use of piezo electric stage motion can minimize some of the Abbe error effects inherent in the majority of the prior art. However, none of the prior art inventions provide a means to control errors in orthogonal and rotational motions (i.e., parasitic motion errors). This is also true for parasitic motions relative to the optical axis. As the focal depth of field is reduced by the use of high numerical aperture objective lenses, the dependence of the focal spot positioning relative to the target surface becomes more critical.

The prior art does not have the ability to introduce an intentional tilt of the sample surface plane in a roll, pitch, and yaw direction while also creating linear motion in X, Y and Z to the optical axis. Control in the rotational axis is highly desired for accurate positioning in all three linear axes. It can also be useful for ablating or adding material in other than approximately round shapes.

As a consequence of the above, the prior art has specific and inherent limitations in ability to compensate for the described motion errors resulting from mechanical construction tolerances and separated motion control. Accordingly, it is desirable to provide a method and apparatus that enables a sample to be positioned on a surface such that any errors inherent in a system are minimized.

### SUMMARY OF THE INVENTION

The foregoing needs are met, to a great extent, by the present invention, wherein in one aspect an apparatus is provided that in some embodiments, the present invention corrects for undesirable position errors whether such errors are caused by Abbey errors, cross coupling errors, or other positional errors.

The present invention provides a system including a lasing device or other type of beam removal and additive device and a device for moving a target sample relative to a beam generated by the lasing device. In combination with sample movement, the beam also contains sufficient energy that, when the beam is focused to a small diameter spot, the beam causes the surface material on a sample to be ablated. Alternatively, if the beam is a laser beam, the laser energy can be chosen such that, in the presence of selected gases or liquids, material deposition occurs on the surface. In the present invention the laser beam may be either continuous or pulsed. In applications where nanometer range surface modifications are desired, the beam must be focused to the smallest possible spot diameter. This invokes certain optical principles. The wavelength of the laser beam should be short and the included angle of the beam, as it exits the final focusing lens, must be as wide as possible. In combination, these attributes will make the diffraction limit of the focused image small. In such instances, the depth of field will necessarily be very short. Consequently, along the axis of the beam, the spatial positioning of the sample surface and the final focusing lens must be precisely controlled.

The laser beam energy may be pulsed to control the amount of material removed and to control the mechanism by which the material is removed. In this embodiment, the pulse duration may include pulse durations in the femto-second range.

The present invention uses an apparatus with stable optical mechanical design for high precision laser machining or deposition. The apparatus utilizes piezo driven stages to move the sample (with minimal parasitic errors) in the X, Y, and Z directions while holding the critical optical components fixed relative to the sample. The result is that the laser focus point can be fixed in space during the process of removing material from the sample. The present invention also may include piezo actuators to rotate the stage in a roll, pitch, and yaw direction.

Further, the present invention includes sensing devices that provide information about the actual cross coupled errors in translational and rotational axis. This information may then be used to instruct the actuator components in the stage to offset or correct for the undesired parasitic or cross coupled translations and rotations. Under appropriate conditions, parasitic motion corrections can be made “real-time”, thereby, maintaining the desired motion with minimal error.

An advantage of this method and apparatus is that precise positioning of the target material, especially in the direction of beam axis, is maintained relative to the focal volume of the laser without parasitic errors or backlash. The same advantage results in the X and Y direction. Accurate positioning in all directions is obtained with minimal Abbe errors and minimal parasitic motion. Small movement is especially accurate and placement of the target relative to the laser beam focal point is highly repeatable. Further, by adjusting the energy levels of the laser beam, a region of energy density that is smaller than the diffraction limited beam diameter can be achieved. By carefully positioning the target sample in the beam, a region of ablation of the target sample can be also made smaller than the diameter of the beam at the focus position. In the present invention, it is the extreme precision and the six axis of motion control, resulting from the piezo driven stages that make nanometer range sample surface modifications possible. In addition, the piezo stages can position the target sample such that its surface is at an angle to the axis of the beam. This allows for different shaped ablation regions.

The present invention may also include the use of a multi-axis stage with correction for Abby and parasitic motions in combination with an atomic force microscope when such microscope is used to remove or add material to a sample surface. Alternatively, other energy sources could be used for adding or removing material, including, FIB and electron beam. These same sources could also be used for measuring the locations of created features as well as preexisting features on the sample surface.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of a beam ablation system according to one embodiment of the present invention.

FIG. 2A is a diagram of the cross section of a laser light beam as it passes through the focus point.

FIG. 2B is a perspective view of a laser light beam as it passes through the focus point.

FIG. 3 is a drawing of the piezo stage and its alternate Z position.

FIG. 4 is a drawing of the piezo stage in perspective showing various axis of translation.

FIG. 5 is a drawing of the piezo stage in perspective showing various axis of rotation.

FIG. 6 is a drawing of the laser beam as it converges, showing lines of constant energy density.

FIG. 7 is a drawing cross section of the laser beam showing the intersection of one area of constant energy density with the surface of the target sample.

FIG. 8A is an illustration of the intersection of a line of energy density and the sample surface as the surface is moved or stepped in the Z direction.

FIG. 8B shows the resulting ablation widths from the events described in FIG. 8A.

FIG. 9 shows how non-orthogonalities may be determined.

FIG. 10 illustrates the combination of the present invention with an optical measurement system.

FIG. 11 illustrates the sequence of steps that may be used to with the present invention.

FIG. 12 illustrates alternate embodiments of the present invention.

FIG. 13A illustrates the result of a first ablation.

FIG. 13B illustrates the result of a second ablation.

FIG. 13C illustrates the result of a third ablation.

FIG. 14 illustrates the steps in a multi-line ablation process.

FIG. 15 is a side-view of the multi-axis stage and coarse motion platform according to a preferred embodiment of the present invention.

### DETAILED DESCRIPTION

The invention will now be described with reference to the drawing figures, in which like reference numerals refer to like parts throughout. An embodiment in accordance with the present invention provides precision positioning of a sample in six axis of motion. This precise positioning is made enabled by including precision measurements and by combining coarse and fine motion stages. By using a combination of stages and precise measuring means according to the present invention, normal and typical errors in positioning encountered with prior art systems and devices may be significantly reduced and an improved position capability provided that is not present in prior art systems.

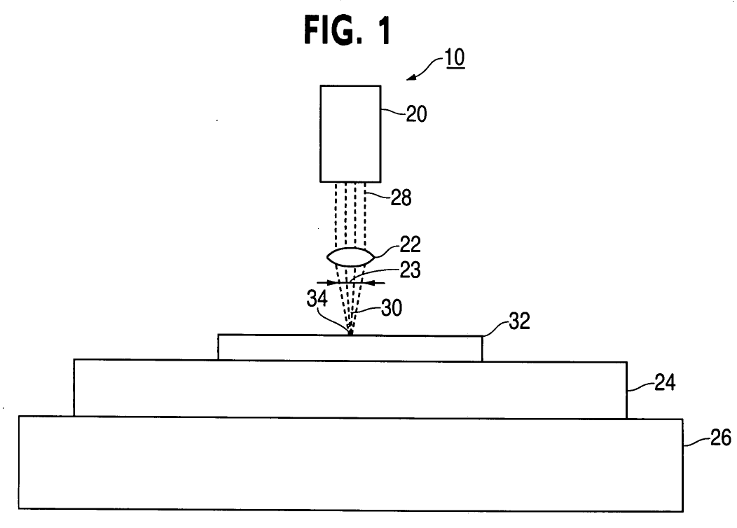

An embodiment of the present inventive apparatus and method is illustrated in FIG. 1. In FIG. 1, a preferred embodiment of the invention shows a laser ablation system 10 comprising a lasing device 20, a focusing lens 22, a multi-axis stage 24 and a coarse motion stage 26. The lasing device 20 preferably emits a light beam 28 with a short wavelength and with a beam diameter that is as large as possible and fills, or may exceed, the diameter of a beam focusing lens 22, which has a high numerical aperture. The numerical aperture is calculated as the sine of half the included angle 23. The included angle 23 is established by the lens diameter and the focal length. The focused beam 30 converges to a focal point at or near the surface of a target sample 32. The target sample 32 resides on a piezostage 24 which in turn is affixed to a coarse motion stage 26.

The lasing device 20 preferably emits a wavelength in the range of 180 nanometers to 300 nanometers with beam 28 having a diameter in the range of 2 millimeter to 10 millimeters. Beam 28 enters the final focusing lens 22 and the lens 22 may have an entry diameter of 2.5 to 3 millimeters. If the beam diameter overfills the focusing lens entry diameter, the lens 22 will vignette beam 28. In this case, the effective numerical aperture of the lens is limited by the diameter of lens 22 and not by the diameter of beam 28 since the exit diameter is fixed by lens 22.

Further, the lasing device 20 preferably is pulsed with pulse durations less than ten picoseconds. Pulse durations in this region have the advantage of cleanly removing material from the sample, and producing surface affected areas smaller than the diffraction limited beam spot size.

The alignment of the lasing device 20 with the focusing lens 22 is critical and it is desirable that this alignment not be disturbed during ablation of material from the target sample 32. Since a volume of material is typically removed from the target sample 32, one advantage is achieved by the precise movement of the sample 32 relative to laser beam focal point 34. This precise movement is accomplished by the multi-axis stage 24. The multi-axis stage 24 can move the sample in three translational axes X, Y and Z and rotated in the roll, pitch, and yaw axes. Any non orthogonalities or parasitic errors are measured and compensated for by actuating one or more of the other translational or rotational axes with complex errors possibly requiring adjustment of up to all six axes.

In order to remove material from the target sample 32, the target sample 32 is precisely positioned such that the location on sample 32, that is to be ablated, is positioned in X, Y, and Z relative to a point is space at which the laser beam 30 is at its smallest diameter. The laser 20 is then pulsed and a portion of the sample 32 is ablated.

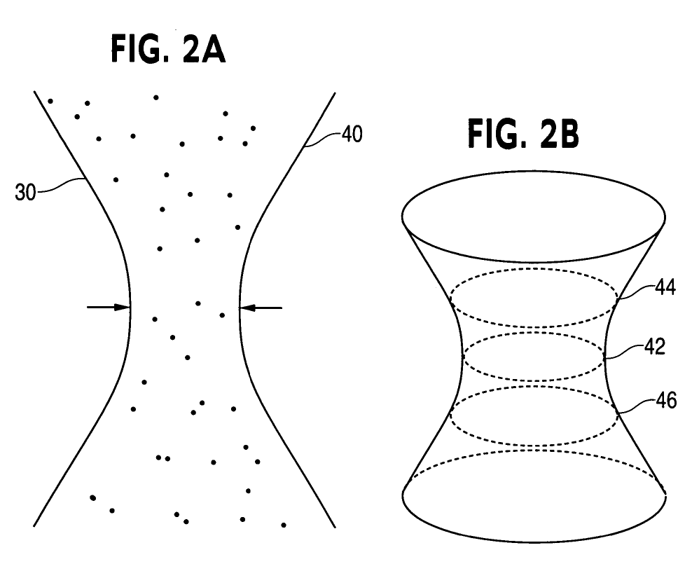

Referring to FIG. 2, a description of the shape of a laser beam 40 is shown. Laser beam 40 is preferably circular and decreasing in diameter as it approaches focal point 42. As previously mentioned, the Abbe limit prohibits the diameter of beam 40 from focusing to an infinitely small point. The result is that the diameter of beam 40, at position 42, is finite and defined approximately by the formula

$$D = \frac{γ}{2 N \cdot A}$$

Where D is the diameter of the beam γ is the wavelength of the beam and N.A. is the numerical aperture.

Additionally in FIG. 2A, a section of the light beam 40 is shown as it appears above, at, and below the focus point. Above the focus point, the beam is converging, as also described in FIG. 1, and would converge to a point if it were not for the diffractions effects described earlier. Below the focus point, the beam begins to diverge. At the focus point, the beam reaches a finite minimum diameter.

FIG. 2B shows various diameters that would appear as spots if the beam 40 were intercepted by the surface of the target sample 32 shown in FIG. 1. In the converging section, the spot would have an upper diameter 44. At the focus point, a focus diameter 42 would be smaller than the upper diameter 44. Below the focus point, a lower diameter 46 would be larger than the focus diameter 42.

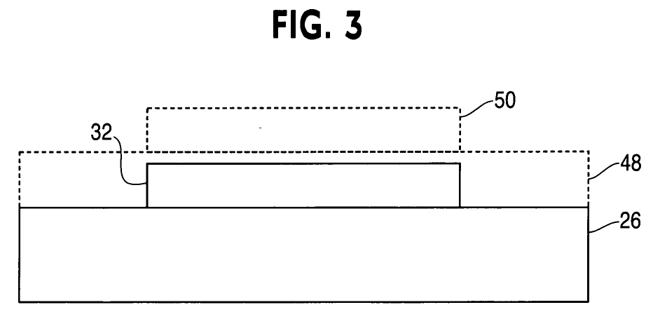

FIG. 3 indicates how the Z-axis of motion of piezo stage 24 would move to an alternate position 48 and the target sample 24 would then be forced to an alternate position 50. This move in the Z axis will be shown to be important to the operation in subsequent figures.

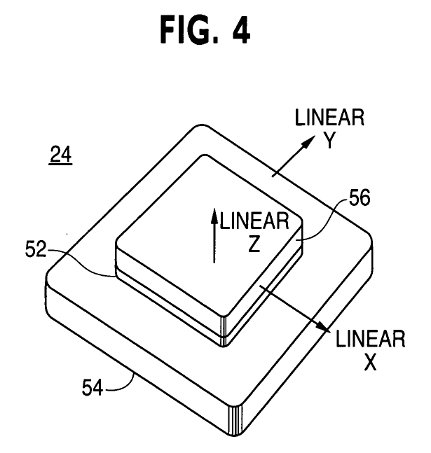

FIG. 4 shows the operation of the piezo stage 24 as it moves in the linear X, Y and Z directions. The piezo actuator 52 is mounted to a base 54 and drives the stage 24 by moving a piezo stage table 56. When the target sample 32 is mounted on the piezo stage 24, its spatial relationship with the beam 28 can be controlled. By moving in the X and Y directions, the target sample 32 can be positioned such that it is directly under the central axis of the beam 28. By moving the target sample 32 in the Z direction, the intersection of the target sample 32 with the beam 28 and therefore any one of the spot diameters 42, 44, and 46 may be projected onto the surface of the target sample 32.

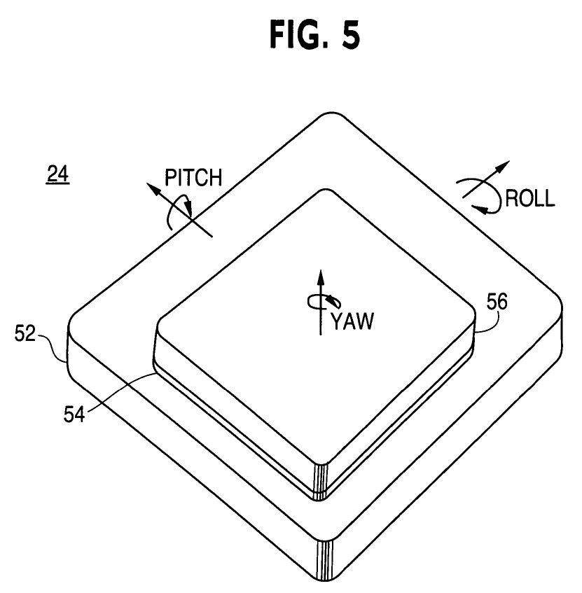

FIG. 5 shows that in addition to the axes of motion described in FIG. 4, the piezo stage 24 may be rotated about the lateral and vertical axis creating roll, pitch, and yaw of the surface of the piezo stage 24, which is ultimately transmitted to the target sample 32, when the target sample 32 is in communication with the piezo stage 24. The advantage of this motion is that mechanical imperfections in the construction of the laser ablation system 10 may be compensated to preserve orthogonality between the surface of the target sample 32 and the directional axis of the laser beam 28. In addition, the intersection spot created by the surface of the target sample 32 and the laser beam 28 can be made to create an ellipse instead of a circle. This is useful when it is necessary to create unusual ablated shapes on the target sample 32.

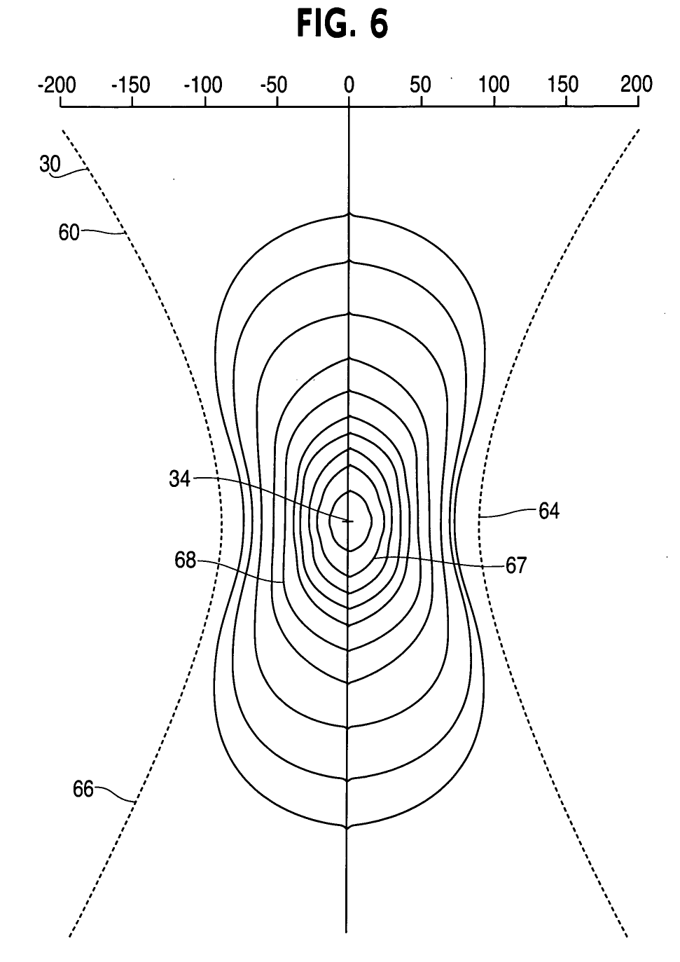

FIG. 6 is a plot of the cross section of the beam 30 with the closed lines representing lines of constant energy density. Again, the beam 30 is wider in a converging portion 60 of the beam 30 than a beam diameter at a focus 64 and also wider in a diverging portion 66. The closed lines representing greater density are nearer the center of the axis of the diffraction limited beam 30. The important aspect of this plot is that the lines identifying increased energy density at the diffraction limited beam waist 64 are smaller in cross section than the cross section of the beam waist 64.

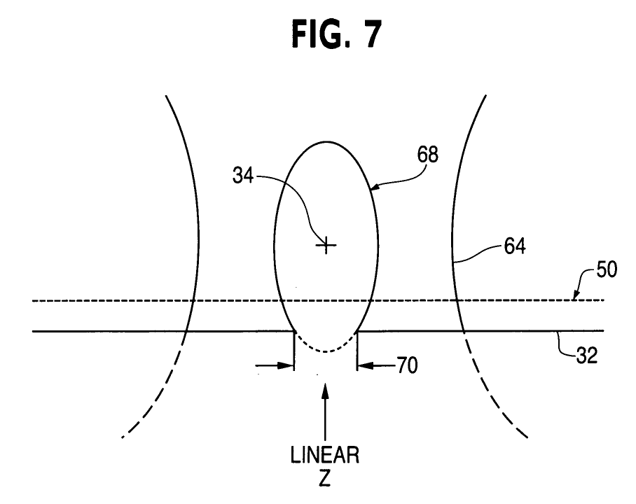

The per pulse energy of the lasing device 20 may be reduced and therefore the closed line of constant energy density 68 needed to create ablation will change to closed line 67. The closed line 67 is smaller and therefore causes a smaller area of ablation. The importance of this feature is described in more detail in FIG. 7.

Referring to FIG. 7, the intersection of the surface of the sample 32 with the beam 30 is shown. A line of constant energy density 68 sufficient to cause ablation is shown intersecting with the surface of sample 32. The diameter of constant density line 68 is controlled by the energy level of the lasing device 20 and the numerical aperture (N.A.) of focusing lens 28. Shown in FIG. 7 in cross section, the ablation diameter 70 is the intersection with the surface of the sample 32 and the diameter 70 is noticeably smaller than the diameter of the beam waist 64. By controlling the intersection point of the surface of the sample 32 and the size of energy density line 68, i.e., by controlling the intensity of beam 28 and the N.A of lens 23, the diameter of ablation 70 may be controlled and set to be less than the diameter of the beam waist 64. The surface of the sample 32 is also shown in the alternate position 50 as an illustration of how movement in the linear Z direction can change the diameter 70 of the ablated area on the sample surface 32.

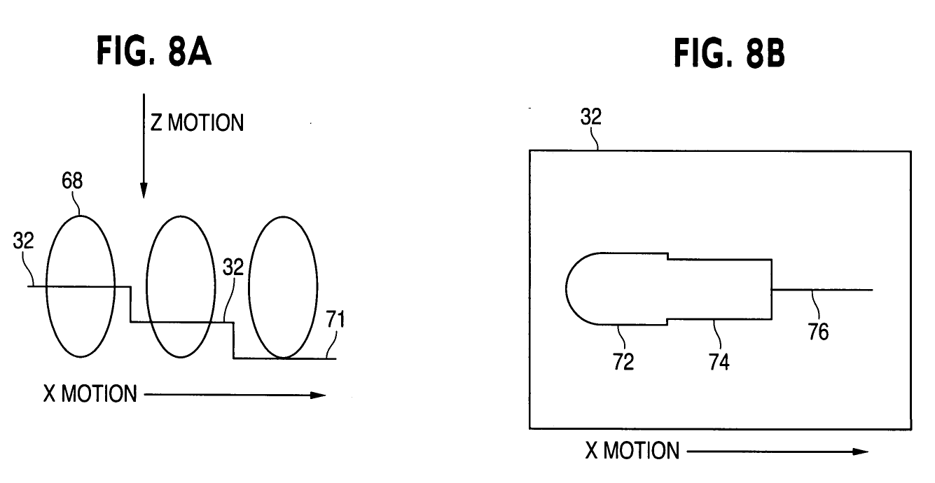

An additional embodiment of the invention may be understood by referring to FIG. 8A. As the surface of sample 32 is moved in one direction, the example shown is for the X direction, the piezo stage 24 is stepped in the Z direction. The resulting ablation width is now shown in FIG. 8B. As is seen, since the diameter of the ablation 70 changes when changing the height of the surface of the sample 32 relative to the height of the energy density line 68, the width of ablation changes from a first width 72 to a second width 74 and again to a third width 76 with each width corresponding to a position of the surface of the sample 32. By observing the widths and then correlating to the known Z values of the surface of the sample 32, a calibration of the ablation system 10 may be made.

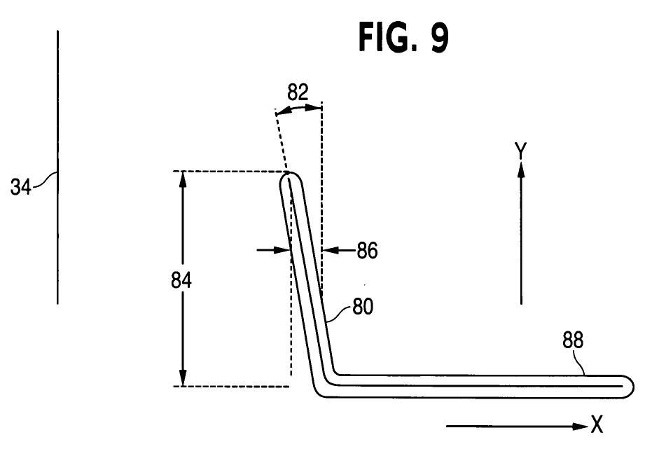

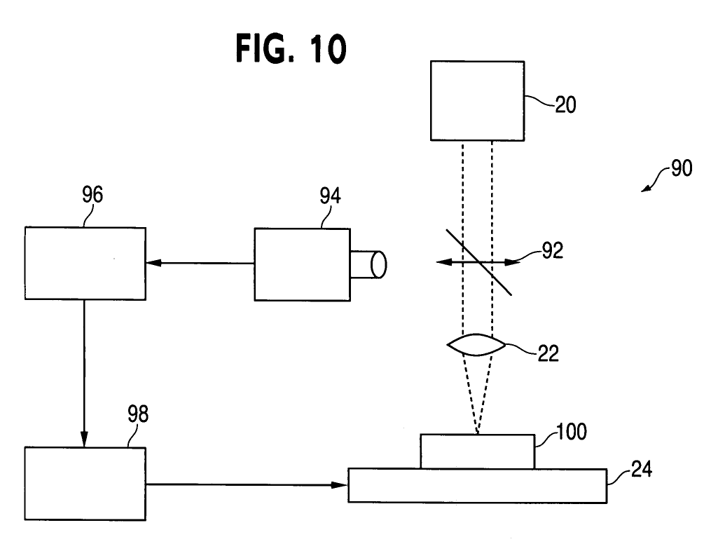

Another alternate embodiment of the invention is shown with reference to FIG. 9 and FIG. 10. FIG. 9 indicates, from a top view, the track, of a pattern of ablation on the surface of the sample 32 created while moving the sample first in the X direction and then in the Y direction. As is illustrated, the motion in the Y direction is not strictly orthogonal to the motion in the X direction. As illustrated in the Y direction, the ablation track 80 actually tracks along a deviant angle 82 from the true orthogonal direction. After tracking a distance 84 in the nearly Y direction, an offset 86 is present. If the longer track 84 continues to deviate from the true orthogonal direction, then track 84 has a greater offset 86.

In order to compensate for the errors generated by non-orthogonal motion, the present invention employs an observation and control system 90 as shown in FIG. 10. In addition to lasing device 20, focusing lens 22, and piezo stage 24, a partially reflecting mirror 92 is employed along with a visual observing device 94, a computing device 96, and a piezo stage controller 98. The observing device 94 observes the ablation tracks made by lasing device 20 on the surface of sample 100 and sends the observed values to computing device 96. The computing device 96 is programmed to calculate the location errors in the ablation tracks. The computing device 96 then sends correction information to piezo stage controller 98, which then sends signals to the piezo stage 24 that cause it to move on a line that is orthogonal to the X axis.

Another feature of the present invention is that lens 22 serves a dual purpose. One feature used to measure the ablation results with the second one being to focus the beam of laser 20 on the surface as described in FIG. 1.

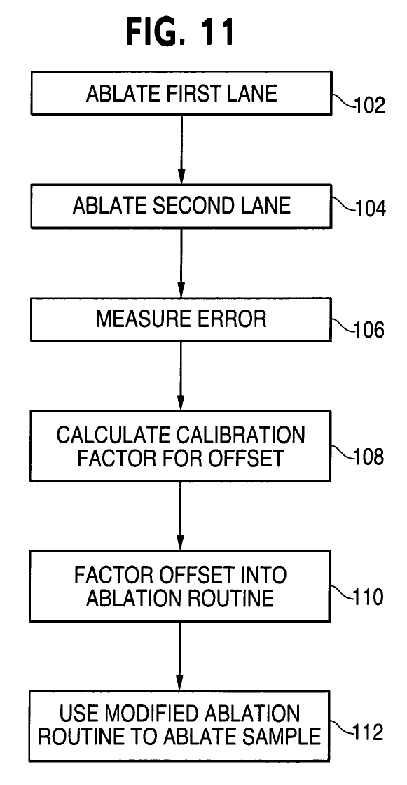

FIG. 11 summarizes the sequence of steps implemented by observation and control system 90 of FIG. 10. In a first step 102, a first ablation line is created in a calibration. This is followed by a second step 104 wherein a second line is created that is presumed to be an ablation line that is orthogonal to the first line also created on the calibration sample. The third step 106 measures any offset. The fourth step 108 calculates a calibration factor for the offset. In the fifth step, 110, the calibration offset factor is sent to the ablation routine. In the sixth step 112, the modified routine is used to ablate the final sample. In this manner, the actual ablation regions can be controlled too much tighter tolerances and sample surface modification in the nano-meter region can be accurately made.

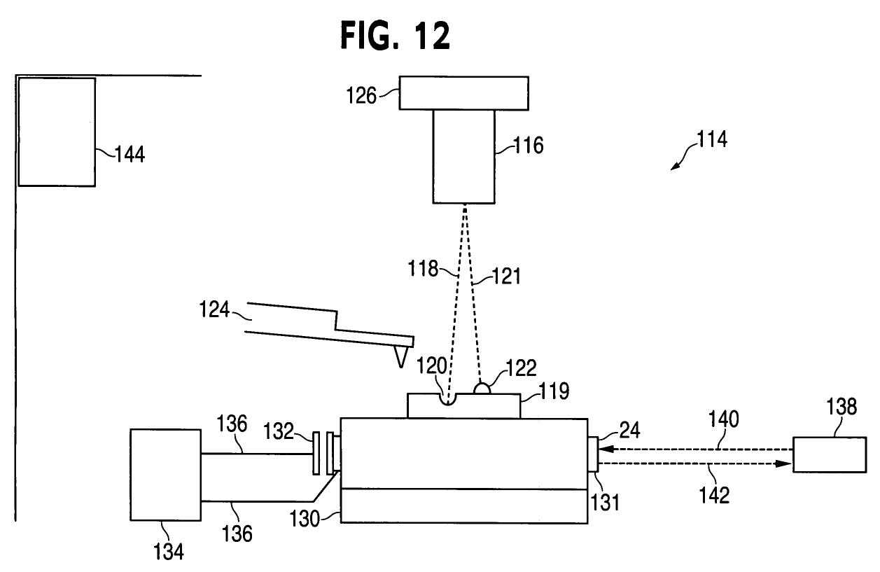

As may be appreciated by studying FIG. 12, the present invention may be a system 114 that includes other types of devices to remove or add material to the sample surface. These may include an output device 116 such as ion beam or alternately an electron beam device. In FIG. 12, the output device 116 may remove material from the surface of a photo-mask 119. As may be appreciated, other types of samples may have material removed 120 or added 122 when the beam is in alternate position 121. Also, probe microscope device 124 may be used to remove 120 or add material 122 by chemical or mechanical action. The present invention may include devices that remove material using ablation or vaporization, which may be used in combination with multi-axis control.

The present invention may include a device 126 to also move the beam or mechanical machining device in combination with the sample motion device.

A flexure 130, which may be actuated by a piezo device, may be used for creating motion in the multi-axis stage 24. Capacitive sensor or sensors 132 may be used for sensing motion or motions of the multi-axis stage 24. In this case, the signal detector 134 senses changes in the capacitive sensor 132 via the signaling wires 136. An interferometer or plurality of interferometers 138 generating a beam 140, with the return beam 142 reflecting from a mirror 131, may be used for sensing motion of the multi-axis stage 24 in one or more axes. Other sensing mechanisms may also be used and may be employed to sense motion in any or all of the axes of multi-axis stage 24.

The system 114 additionally may be placed under humidity control, temperature control, and or vibration isolation. Such single or multiple controls may be accomplished with a device or devices 144, which are able to track the above listed capabilities.

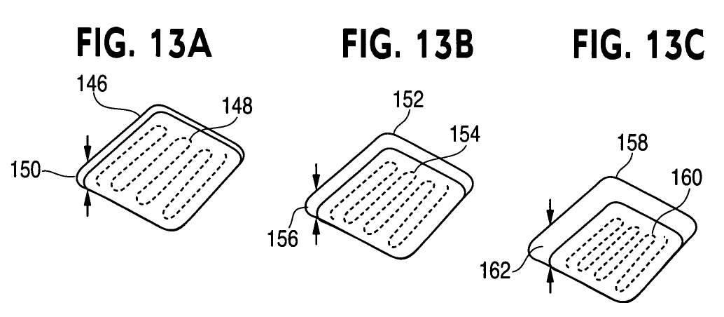

FIGS. 13A, 13B, and 13C show the results of a sequence of ablations to increase depth. This technique is referred to as a multipass ablation.

FIG. 13A illustrates the ablation results of the light beam 28 with the laser per pulse energy set at a level to create a minimum sized spot on the surface of target sample 32. This ablation is the first in a series of ablations. The light beam 28 is moved across the surface of the sample 32 to create an ablation in the first area 146 tracking a first pattern 148 resulting in a first ablation depth 150.

FIG. 13B illustrates the ablation results of the light beam 28 with the laser per pulse energy reset to a new level, or alternately the Z position of the sample is reset, or incremented, to a position closer to the lasing device 20. This ablation is the second in the series of ablations. The light beam 28 is again moved across the surface of the sample 32 to create a deeper second ablated area 152 tracking a second pattern 154 resulting in a second ablation depth 156.

FIG. 13C illustrates the ablation results of the light beam 26 with the laser per pulse energy again reset to a third level, or alternately the Z position of the sample is reset, or incremented, to a third position closer to the lasing device 20. This ablation is the third in the series of ablations. The light beam 28 is again moved across the surface of sample 32 to create a deeper third ablated area 158 tracking a third pattern 160 resulting in a third ablation depth 162.

As the process of the embodiment of the invention just describe progresses, it is important to note that each ablation step must be properly registered with the previous step. This can be accomplished with very high accuracy utilizing the current invention, because Abbe errors are minimized. This is also true for the Z-axis steps described above, because the X and Y parasitic motion during Z moves can be compensated.

It is also important that the ablation steps be properly registered to features on the target surface. This can be best achieved when the observing device 94 and focusing lens 22 are the same. In the case of a mechanical material removal method, again best registration is achieved when the probe microscope 124 is used to both observe and remove material. In the case of an electron or particle beam device, the best registration is obtained when the ablating beam is also the observing device. The X and Y positioning accuracy must be maintained as each subsequent material removal step is accomplished.

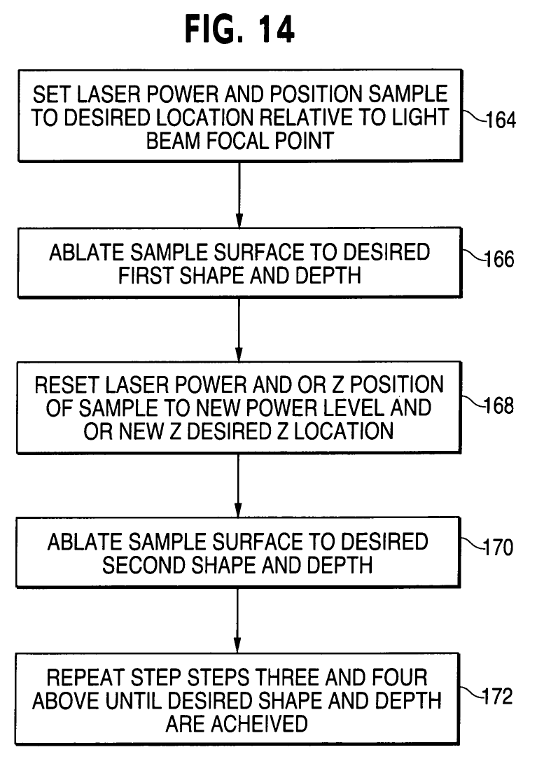

FIG. 14 illustrates the steps of FIGS. 13A, 13B, and 13C. In this sequence, the set per pulse energy step 164 includes setting the per pulse energy of lasing device 20 and positioning the sample 32 at a specified Z location relative to lasing device 20. Next, in the ablate step 166, the sample 32 or light beam 28 is moved in a predetermined pattern to create a desired ablated area. In the reset step 168, the per pulse energy of lasing device 20 or the Z location of sample 32 relative to lasing device 20, or both, can be reset and relative motion between sample 32 and light beam 28 is created. In a second ablate step 170, the sample is further ablated resulting in a deeper and/or possibly new ablated areas. The sequence of steps may be repeated 172 until the desired shape and depth of the ablated area is achieved.

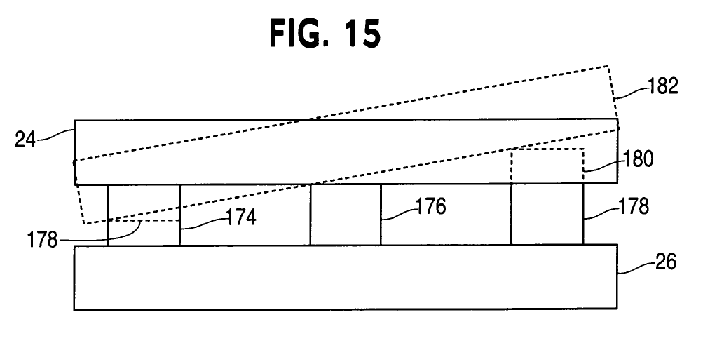

FIG. 15 is a side-view of the multi-axis stage 24 and coarse motion platform 26 according to a preferred embodiment of the present invention. As is shown in this figure, the multi-axis stage 24 is positioned above the coarse motion platform 26 through the use of a plurality of piezo actuators 174, 176, 178. In the preferred embodiment, the piezo actuators 174, 176, 178 are positioned in a triangular shape, which enables the multi-stage axis to be moved and rotated efficiently in a plurality of directions.

The piezo actuators 174, 176, 178 can be actuated individually or as a whole set or subset. By allowing individually movement of the actuators, the multi-axis stage is able to be moved and rotated in any number of directions as desired in order to reduce or substantially reduce the unintended errors in the system. FIG. 15 illustrates that one of the piezo actuators 178 moved in an upward direction to alternate shape 180 such that the multi-stage axis 24 is moved linearly in a second direction 182 such that the stage is moved in one direction as well as rotated in another.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. An apparatus for positioning a material in the appropriate location such that the material can be modified with a system, comprising:
a multi-axis stage configured to accept the material on an outer surface, wherein the multistage axis is configured to translate or rotate along at least one axis; and
a second stage with at least one axis of motion positioned on an opposing surface of the multi-axis stage.

2. The apparatus as in claim 1, wherein the multi-stage axis is configured to translate with a piezo actuator.

3. The apparatus as in claim 2, wherein the multi-stage axis is configured to rotate with a piezo actuator.

4. The apparatus as in claim 1, wherein the system comprises a laser.

5. The apparatus as in claim 1, wherein the material is modified by selecting one from the group consisting of adding material and removing material.

6. The apparatus as in claim 1, wherein the material is a photomask.

7. The apparatus as in claim 1, wherein the material is a silicon device in process.

8. The apparatus as in claim 1, wherein the material is a flat panel device.

9. The apparatus as in claim 2, wherein the apparatus reduces the effects of Abbe errors and minimal parasitic motion.

10. The apparatus as in claim 4, wherein the laser is of a short pulse duration.

11. The apparatus as in claim 10, wherein the short pulse duration is in the femto-second range.

12. The apparatus as in claim 2, further comprising an observation and control device that is configured to track modification made on the material.

13. The apparatus as in claim 12, wherein the observation and control device further comprises a mirror or a partial reflecting mirror, a computing device and a piezo stage controller.

14. The apparatus as in claim 13, wherein the observation and control device transmits observed values of the modification to the computing device, wherein the computing device is configured to determine an error in the modification.

15. The apparatus as in claim 14, wherein the computing device transmits data to the piezo stage controller.

16. The apparatus as in claim 15, wherein the data is correction data.

17. The apparatus as in claim 16, wherein the system is a laser.

18. The apparatus as in claim 17, wherein a lens is configured to focus a beam of the laser and measure the modification.

19. The apparatus as in claim 2, wherein the multi-stage axis is configured to rotate with a flexure.

20. The apparatus as in claim 19, wherein a sensor is configured to sense motion of the multi-axis stage.

21. The apparatus as in claim 20, wherein the sensor is a capacitive sensor.

22. The apparatus as in claim 1, wherein the system further comprises a temperature control apparatus.

23. The apparatus as in claim 1, wherein the system further comprises humidity control apparatus.

24. The apparatus as in claim 1, wherein the system further comprises a vibration isolation apparatus.

25. The apparatus as in claim 1, wherein the system further comprises a robotic sample handling apparatus.

26. The apparatus as in claim 1, wherein the second stage is configured to move in a course motion.

27. A method for positioning a sample relative to a system such that the sample could be modified, comprising:
positioning the sample on a multi-axis stage, wherein the stage is translational and rotational along an axis; and
positioning the multi-axis stage on a second stage.

28. The method as in claim 27, further comprising positioning the sample with the multi-stage axis relative to the system, wherein the system is configured to modify the sample.

29. The method as in claim 28, wherein modifying the sample comprises removing material.

30. The method as in claim 29, wherein modifying the sample comprises adding material.

31. The method as in claim 27, further comprising modifying the sample with a laser.

32. The method as in claim 31, wherein the laser is a short pulse duration laser.

33. The method as in claim 32, wherein the short pulse duration laser is in the femto-second pulse range.

34. The method as in claim 27, further comprising sensing a movement of the sample on the multi-stage axis.

35. The method as in claim 34, wherein the step of sensing is accomplished with a capacitive sensor.

36. The method as in claim in 31, further comprising observing the modification of the sample.

37. The method as in claim 36, further comprising determining a presence of an error while the sample is being modified.

38. The method as in claim 37, further comprising correcting the error.

39. The method as in claim 38, wherein the step of correcting the error comprises transmitting correction information to a multi-stage axis controller and adjusting the multi-stage axis in response to the correction information.

40. An apparatus for positioning a material in the appropriate location such that the material can be modified with a system, comprising:
first means for multi-axis staging that is configured to accept the material on an outer surface, wherein the first means for multi-axis staging is configured to translate or rotate along at least one axis; and
a second mean for staging with at least one axis of motion positioned on an opposing surface of the multi-axis stage.

41. The apparatus as in claim 40, further comprising means for adding or removing material from the material.

42. The apparatus of claim 41, wherein the means for adding or removing is a laser.

43. The apparatus of claim 41, wherein the means for adding or removing is a FIB source.

44. The apparatus of claim 41, wherein the means for adding or removing is an electron beam source.

45. The apparatus of claim 42, wherein the laser is pulsed.

46. A method for adding or removing material from a target surface with high precision relative to surface features comprising:
positioning the sample on a multi-axis stage, wherein the stage is translational and rotational along an axis;
positioning the multi-axis stage on a second stage; and
directing a source of energy at or near the surface.

47. The method of claim 46 further comprising measuring the location of the added or removed material.

48. The method claim 47, wherein the source of energy is used for both measurement and adding or removing material.
